(19) United States
(12) Patent Application Publication
(10) Pub. No.: US 2015/0088648 A1
(43) Pub. Date: Mar. 26, 2015

(54) DETERMINING COMMERCIAL INTENT

(71) Applicant: Google Inc., Mountain View, CA (US)

(72) Inventors: Laukik Vilas Chitnis, Sunnyvale, CA (US); Yue Kwen Justin Yip, Sunnyvale, CA (US)

(73) Assignee: Google Inc., Mountain View, CA (US)

(21) Appl. No.: 14/035,262

(22) Filed: Sep. 24, 2013

(51) Int. Cl. G06Q 30/02; G06F 17/30

(52) U.S. Cl. CPC G06Q 30/0256; G06F 17/30522
USPC 705/14.54

(57) ABSTRACT

Methods, systems, and apparatus, including computer programs encoded on a computer-readable storage medium, for providing content. A query is received that includes a plurality of terms or phrases. Entities associated with the plurality of terms or phrases are identified. For each identified entity, one or more collections of entities are determined. A determined collection of entities includes a respective identified entity as a member. A commercial intent of a user that submitted the query is determined, including evaluating the determined one or more collections of entities. Based on the determined commercial intent, a decision is made when to deliver additional content items along with search results that are responsive to the query.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a computer-implemented method for providing content. The method includes receiving a query including a plurality of terms or phrases. The method further includes identifying entities associated with the plurality of terms or phrases. The method further includes, for each identified entity, determining one or more collections of entities wherein a determined collection of entities includes a respective identified entity as a member. The method further includes determining a commercial intent of a user that submitted the query including evaluating the determined one or more collections of entities. The method further includes, based on the determined commercial intent, deciding when to deliver additional content items along with search results that are responsive to the query.

These and other implementations can each optionally include one or more of the following features. Determining one or more collections can include determining a collection that includes all of the identified entities. Determining a commercial intent can include evaluating the criteria for inclusion in a collection and using the criteria to infer commercial intent. Deciding can include deciding to deliver additional content items when the commercial intent is determined to be an intent to purchase a good or service. Deciding can include deciding to not deliver additional content items when the commercial intent is determined to not be an intent to purchase a good or service. The additional content items can be advertisements. The method can further include using the determined one or more collections to select the additional content items to be delivered along with the search results. Determining one or more collections can include determining that one of the one or more collections is a blacklist collection, and determining the commercial intent of the user can include inferring that the commercial intent of the user that submitted the query is not to purchase a good or service based on the identification of the blacklist collection. A collection can be a group of entities that share a common characteristic.

In general, another innovative aspect of the subject matter described in this specification can be implemented in computer program products that include a computer program product tangibly embodied in a computer-readable storage device and comprising instructions. The instructions, when executed by one or more processors, cause the processor to: receive a query including a plurality of terms or phrases; identify entities associated with the plurality of terms or phrases; for each identified entity, determine one or more collections of entities wherein a determined collection of entities includes a respective identified entity as a member; determine a commercial intent of a user that submitted the query including evaluating the determined one or more collections of entities; and based on the determined commercial intent, decide when to deliver additional content items along with search results that are responsive to the query.

These and other implementations can each optionally include one or more of the following features. Determining one or more collections can include determining a collection that includes all of the identified entities. Determining a commercial intent can include evaluating the criteria for inclusion in a collection and using the criteria to infer commercial intent. Deciding can include deciding to deliver additional content items when the commercial intent is determined to be an intent to purchase a good or service. Deciding can include deciding to not deliver additional content items when the commercial intent is determined to not be an intent to purchase a good or service. The additional content items can be advertisements. The method can further include using the determined one or more collections to select the additional content items to be delivered along with the search results. Determining one or more collections can include determining that one of the one or more collections is a blacklist collection, and determining the commercial intent of the user can include inferring that the commercial intent of the user that submitted the query is not to purchase a good or service based on the identification of the blacklist collection. A collection can be a group of entities that share a common characteristic.

In general, another innovative aspect of the subject matter described in this specification can be implemented in systems, including a system for providing content. The system includes an annotator for annotating each of one or more received search queries with one or more entities, a commercial intent identifier for receiving annotation results and generating one or more scores for each entity that reflects a likelihood that a particular entity indicates a commercial intent for a user that submits the request, and a content item matcher for using the identified entity to serve content that is responsive to the received query.

These and other implementations can each optionally include one or more of the following features. Determining a commercial intent includes evaluating criteria for inclusion in a collection and using the criteria to infer commercial intent.

Particular implementations may realize none, one or more of the following advantages. Content recommendations can be provided to a user without relying on purchasing histories of one or more users. The content recommendations can be provided based on a determination that a request for content has an associated commercial intent, which may improve user interactions with the content and increase revenue generated when providing the content. Disambiguation of terms received by a user as part of a search query can be improved based at least in part on determining the commercial intent of the user.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content to a user.

FIG. 2 is a block diagram of an example system for providing content to a user.

FIG. 3 is a block diagram of an example commercial intent identifier.

FIG. 4 is a flowchart of an example process for determining commercial entity relationships.

FIG. 5 is a block diagram of computing devices that may be used to implement the systems and methods described in this document, as either a client or as a server or plurality of servers.

Like reference numbers and designations in the various drawings indicate like elements.

### DETAILED DESCRIPTION

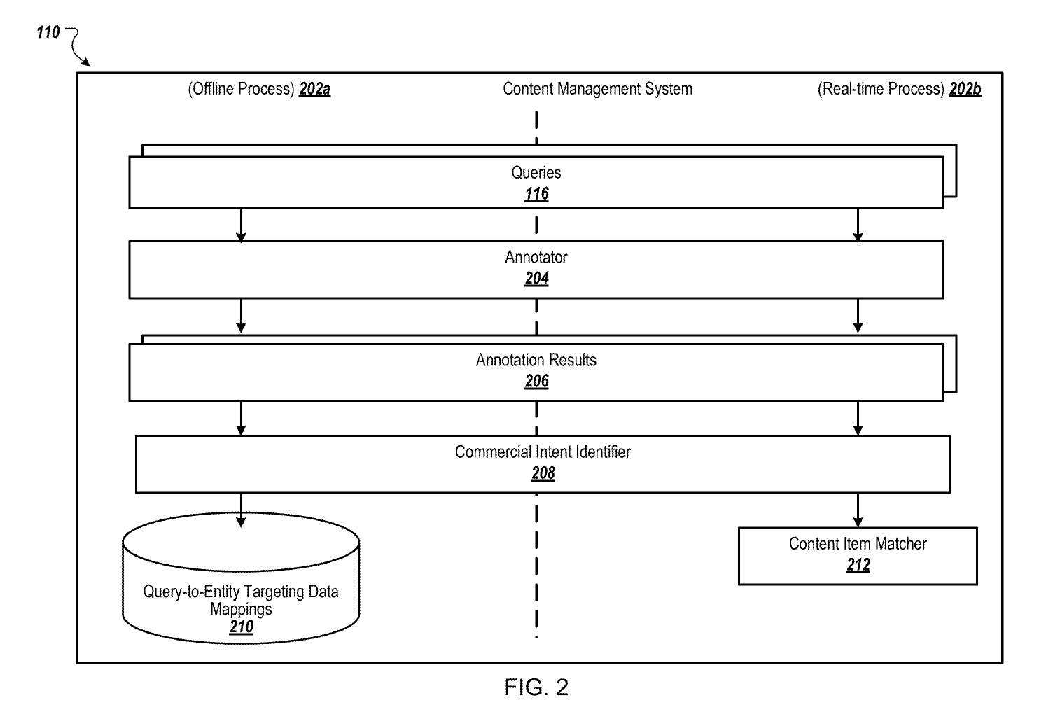

In general, the subject matter of this disclosure relates to determining commercial intent of a user using one or more entity relationships for one or more entities. In general, an entity can be a person, place, product, service, vertical, concept or abstract idea. The determined commercial intent can be used to generate selection criteria for one or more content items, e.g., advertisements, which may be provided to the user. The determination of commercial intent can be made by evaluating identified entities in a received request. The identified entities can then be evaluated to determine a collection for which respective ones of the entities belong. In general, a collection is a group of entities that share a common characteristic. For example, there may be a movies collection that includes one or more entities associated with movies, although a large number of collections are possible according to how entities are categorized. Also, in some implementations, different collections can include the same entities. For example, a collection for football players—or for hall of fame football players—includes the entity “Jim Brown” while a collection for movie stars can also include the entity “Jim Brown.” Multiple collections may be used to evaluate the commercial intent of the particular request. For example, certain collections may be more indicative of commercial intent than other collections. Additional, details of determining commercial intent of a user are discussed below in association with FIGS. 2, 3, and 4.

In some implementations, the commercial entity relationship determination can be made by evaluating information stored in a content item repository (e.g., such as a database that includes information corresponding to one or more advertisements that can be provided to a user in response to receiving a content request or search query). In some implementations, the commercial entity determination process can be used so as to ensure delivery of more relevant content in response to the received requests or search queries. More specifically, when a request or query is received, the request may include or be associated with metadata (that define characteristics of a given slot/impression or keywords) that defines conditions, requirements, or other criteria that should be considered/satisfied in order to ensure a highly relevant content item is returned responsive to the request or query. When keywords are provided, the keywords themselves may be ambiguous. Accordingly, in some implementations, identifying entities associated with these keywords may be helpful to better satisfy a given request/query.

Even where entities are used, some ambiguity may still exist because the context in which a particular keyword is used may make it difficult to determine which entity should be selected for the particular keyword. For example the keyword Jaguar, may refer to the mammal, the automobile, or the insect, where each of these are themselves different entities. In order to determine a context or resolve ambiguity in these situations, determining a likely entity from among the available entities can be performed using a commercial entity determination process, e.g. by determining a commercial intent of a user and selecting those entities that are commercial in nature.

This process can be used to determine relevant entities to associate with a particular adgroup or to resolve ambiguity when evaluating received keywords that are used to select which content to deliver. In the examples provided below, processes are described for determining a commercial intent and then selecting a particular entity or collection of entities when a commercial intent has been determined. Those processes can be used in numerous ways. In some embodiments, as the system performs one or more techniques described herein, additional commercial relationships can be determined (e.g., using an iterative process) and the overall relevance of content items delivered by such a system can be improved.

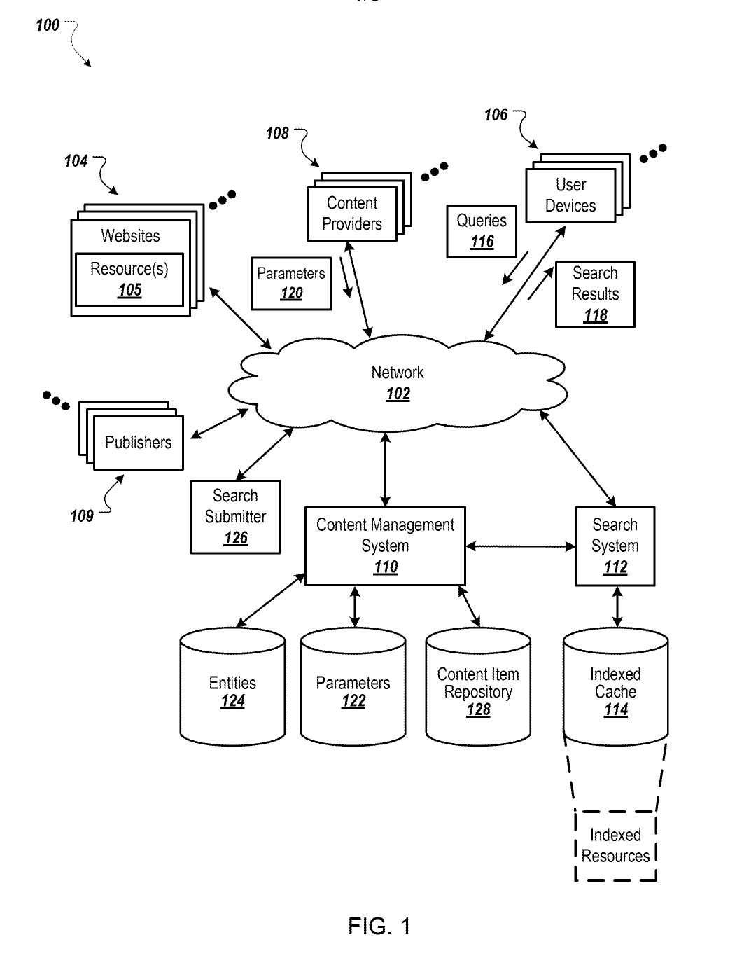

FIG. 1 is a block diagram of an example environment 100 for providing content to a user. The example environment 100 includes a network 102 such as a local area network (LAN), wide area network (WAN), the Internet, or a combination thereof. The network 102 connects websites 104, user devices 106, content providers 108 (e.g., a content provider 108a and a content provider 108b), publishers 109, and a content management system 110. The example environment 100 may include many thousands of websites 104, user devices 106, content providers 108, and publishers 109.

A website 104 includes one or more resources 105 associated with a domain name and hosted by one or more servers. An example website 104 is a collection of webpages formatted in hypertext markup language (HTML) that can contain text, images, multimedia content, and programming elements, e.g., scripts. Each website 104 is maintained by, for example, a publisher 109, e.g., an entity that controls, manages and/or owns the website 104.

A resource 105 is any data that can be provided over the network 102. A resource 105 is identified by a resource address that is associated with the resource 105. Resources 105 include HTML pages, word processing documents, and portable document format (PDF) documents, images, video, and feed sources, to name only a few examples. The resources 105 can include content, e.g., words, phrases, images and sounds that may include embedded information (such as meta-information in hyperlinks) and/or embedded instructions (such as scripts).

To facilitate searching of resources 105, the environment 100 can include a search system 112 that identifies the resources 105, for example, by crawling and indexing the resources 105 provided by the publishers 109 on the websites 104. Data about the resources 105 can be indexed based on the resource 105 to which the data corresponds. The indexed and, optionally, cached copies of the resources 105 can be stored in an indexed cache 114.

A user device 106 is an electronic device that is under control of a user and is capable of requesting and receiving resources 105 over the network 102. Example user devices 106 include personal computers, mobile communication devices, tablet devices, and other devices that can send and receive data over the network 102. A user device 106 typically includes a user application, such as a web browser, to facilitate the sending and receiving of data over the network 102 and the presentation of content to a user.

A user device 106 can request resources 105 from a website 104. In turn, data representing the resource 105 can be provided to the user device 106 for presentation by the user device 106. User devices 106 can also submit search queries 116 to the search system 112 over the network 102. In response to a search query 116, the search system 112 can access the indexed cache 114 to identify resources 105 that are relevant to the search query 116. The search system 112 identifies the resources 105 in the form of search results 118 and returns the search results 118 to the user devices 106 in search results pages. A search result 118 is data generated by the search system 112 that identifies a resource 105 that is responsive to a particular search query 116, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

In some implementations, slots on search results pages or other webpages can include content slots for content items that have been provided as part of a reservation process. In a reservation process, a publisher and a content item sponsor enter into an agreement where the publisher agrees to publish a given content item (or campaign) in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource (“resource keywords”) or a search query 116 for which search results 118 are requested can also be provided to the content management system 110 to facilitate identification of content that is relevant to the resource or search query 116. A request for a resource 105 or a search query 116 can also include an identifier, such as a cookie, identifying the requesting user device 106 (e.g., in instances in which the user consents in advance to the use of such an identifier).

Based, for example, on data included in the request for content, the content management system 110 can select content items that are eligible to be provided in response to the request, such as content items having characteristics matching the characteristics of a given slot. As another example, content items having selection criteria (e.g., keywords) that match the resource keywords or the search query 116 may be selected as eligible content items by the content management system 110. One or more selected content items can be provided to the user device 106 in association with providing an associated resource 105 or search results 118.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). When multiple slots are allocated in a single auction, the slots can be allocated to a set of bidders that provided the highest bids or have the highest auction scores.

In some implementations, some content providers 108 prefer that the number of impressions allocated to their content and the price paid for the number of impressions be more predictable than the predictability provided by an auction. For example, a content provider 108 can increase the likelihood that its content receives a desired or specified number of impressions, for example, by entering into an agreement with a publisher 109, where the agreement requires the publisher 109 to provide at least a threshold number of impressions (e.g., 1,000 impressions) for a particular content item provided by the content provider 108 over a specified period (e.g., one week). In turn, the content provider 108, publisher 109, or both parties can provide data to the content management system 110 that enables the content management system 110 to facilitate satisfaction of the agreement.

For example, the content provider 108 can upload a content item and authorize the content management system 110 to provide the content item in response to requests for content corresponding to the website 104 of the publisher 109. Similarly, the publisher 109 can provide the content management system 110 with data representing the specified time period as well as the threshold number of impressions that the publisher 109 has agreed to allocate to the content item over the specified time period. Over time, the content management system 110 can select content items based at least in part on a goal of allocating at least a minimum number of impressions to a content item in order to satisfy a delivery goal for the content item during a specified period of time.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 120 which define the content campaign. The content campaign can be created and activated for the content provider 108 according to the parameters 120 specified by the content provider 108. The campaign parameters 120 can be stored in a parameters data store 122. Campaign parameters 120 can include, for example, a campaign name, a preferred content network for placing content, a budget for the campaign, start and end dates for the campaign, a schedule for content placements, content (e.g., creatives), and selection criteria. Selection criteria can include, for example, a language, one or more geographical locations or websites, and one or more selection terms (e.g., keywords). As another example, a content provider 108 can annotate some or all selection criteria with one or more entities. In general, an entity can be named and can represent, for example, a person (e.g., celebrity, president), place (e.g., national park, city), thing (e.g., ice cream, sweater), or concept (e.g., biology, motherhood)). Other examples of entities include a product, service, organization, vertical, or abstract idea. A group or category of entities can be considered to be an entity (e.g., baseball players).

Annotating selection criteria with one or more entities can result in a better user experience than if a more basic matching of selection criteria to a request keyword is performed. For example, for some selection criteria, a simple match of a selection criteria keyword to a request keyword may not result in an appropriate content item being selected for the request. For example, a request keyword may be the word “firing”, which, if a simple match is performed, may be matched to content items having selection criteria related to “firing a weapon”, “firing an employee”, “firing (e.g. igniting) a fireplace”, etc. The content provider 108, who can be, for example, a human resources consulting firm, can, as part of configuring a campaign, associate, for example, an entity that represents a concept of “firing an employee” to a particular content item, group of content items, or a campaign. That way, the content provider's 108 content (e.g., related to firing employees) won't be presented when a request comes in, for example, for a website that relates to pottery (e.g., where “firing” for this type of entity refers more likely to the process of turning the clay into a finished product).

Similarly, by determining whether a provider of a search query is indicating a commercial intent, a better user experience can result. For example, more appropriate content items can be selected as being responsive to a particular request, such as search query 116. In a particular example, a first collection of content items may be responsive to the search query 116 and are related to a first commercial entity named “Jaguar” (and being associated with a first entity identifier). This first collection of content items may be substantially different to other collections of content items that may also be responsive to the search query 116 but are related to one or more other commercial or non-commercial entities named “Jaguar” (and being associated with a second entity identifier). If, for example, the search query 116 uses the term Jaguar, the non-commercial entity named “Jaguar” may be selected when the commercial entity named “Jaguar” was intended by the provider of the search query 116. Instead, if one or more other terms appear in the search query 116 with the term “Jaguar” that that may indicate a commercial intent, then the content items from the first collection can be provided in response to receiving the search query 116. In some implementations, other intent bearing words or phrases directed to the purchasing of a particular good or service may also indicate a commercial intent of the provider of the search query 116.

The content management system 110 can use selection criteria and annotated entities when evaluating received requests for content. For example, a search query 116 can be received that includes an entity designation. For example, a user can be provided with and can select one or more entity suggestions for an entered search query 116. As another example, an entity can be inferred from a user-provided search query 116. As yet another example, a search query 116 can be received by a computer system, such as a search submitter system 126, where the received search query 116 is annotated with one or more entity designations. The search submitter 126 can, for example, submit a search query 116 that is annotated with an entity designation determined by a knowledge panel.

The content management system 110 can compare request keywords and a received entity designation to selection criteria and an entity designation associated with a content item. The content management system 110 can determine that a match exists between a content request and a content item, such as by determining that an entity designation associated with the content request matches an entity designation associated with the content item. The content management system 110 can select the content item for the content request and can provide the selected content item to the requesting user device 106. Other examples are possible, such as described in more detail below.

In some implementations, information pertaining to one or more content items may be stored in a content items repository 128. The content items repository 128 may be any data store that is suitable for storing relationships between one or more contents items, one or more keywords, one or more landing pages, and combinations of these. For example, the content items repository 128 can be a relational database. In a particular example, the relational database may store relationships between content items (e.g., advertisements) for a particular sports car, one or more keywords or keyword phrases that can be used to describe the particular sports car, and a URL for a landing page that shows the particular sports car. In this particular example, the keywords may include the name of the product (e.g., “Sports Car X”), an attribute or characteristic of the product (e.g., “zero to sixty in 2.5 seconds”), a competitor's product (e.g., “Sports Car Y”), and other keywords.

In some implementations, the content item repository can store information that pertain to one or more content items that correspond to a specific area, theme, or product for a particular content sponsor (e.g., such as a car manufacturer). In some examples, each of these content items can be associated with one or more campaigns. For example, a particular advertising campaign may have one or more different targets (e.g., such as a demographic group) and one or more adgroups of content items that are directed to at least some of the targets. That is, an adgroup of one or more content items may be a group of content items that target a specific set of keywords or entities. In a particular example, a car manufacturer may wish to provide content items related to a car's safety to a parental demographic and may wish to provide content items related to a car's performance or physical characteristics to a different demographic based at least in part on keywords or terms that corresponding to entities received in a search query 116. In some implementations, an adgroup may have a particular adgroup identifier that differentiates one adgroup from another adgroup in the content item repository 128.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

FIG. 2 is a block diagram of an example content management system 110. As described above, the content management system 110 can provide one or more content items in response to requests for content. The content management system 110 may determine a commercial intent associated with a particular request. The determined commercial intent can be used to improve the accuracy and/or relevance of the one or more content items that are provided in response to the requests for content.

In some implementations, the content management system 110 may be configured to determine a commercial intent using an offline process 202a, a real-time process 202b, or using some combination of an offline process 202a and a real-time process 202b. Used herein, the term “offline process” refers to a process that is performed while the content management system 110 is not providing content to users in response to requests for information. For example, the offline process 202a may be performed in the background or as a batch process during periods of time of low search activity. Also, used herein, the term “real-time process” refers to a process that is performed while the content management system 110 is providing content to users in response to requests for information. For example, the real-time process 202b may be performed in response to receiving a search request from a user. These terms are illustrative to show one or more different workflows, but should not be considered limiting. For example, the offline process 202a may occur while the content management system is connected to other system (e.g., as shown in reference to FIG. 1).

Similarly, the real-time process 202b may occur in pseudo-real time and need not produce immediate results. In general, a difference between the offline process 202a and the real-time process 202b may relate to access to computing resources. For example, an offline process 202a may have access to greater computing resources (e.g., memory, computation cycles, and so forth) than a similar real-time process 202b. As a result the offline process 202a may be performed with fewer limitations and computational restrictions than the real-time process 202b, regardless of when or how the processes actually occur.

The content management system 110 is shown with a number of different components, some of which are used during the offline process 202a, while other components are used during the real-time process 202b, while still other components may be used during both the offline process 202a and the real-time process 202b. These components enable the content management system 110 to determine a commercial intent for a received request and one or more content items that may satisfy the search request based on the determined commercial intent. The content management system 110 includes an annotator 204, a commercial intent identifier 208, a query to entity targeting data mappings repository 210, and a content item matcher 212.

The annotator 204 can be used to annotate one or more received search queries 116. For example, the annotator can use one or more of a parsing, a comparing, or other techniques to determine a match for a particular entity and a particular keyword in the one or more received search queries. In general, the annotator 204 is configured to determine or otherwise identify whether a keyword in the one or more search queries 116 is referring to an entity.

For example a keyword “fast” may not identify a particular entity, while a keyword “Jaguar” may likely be referring to a specific entity. If for example, the annotator 204 determines that a particular term refers to an entity, the term may be associated with one or more designators that indicate the term likely refers to an entity. In some implementations, the designators may include an entity identifier to which the term may refer and a confidence score that specifies a likelihood to which the term refers to the particular entity. For example, because there may be multiple entities that have the name “Jaguar,” such as the car manufacturer, the beetle, the mammal, and so forth, a confidence score can be associated with each of the entities for the car manufacturer, the beetle, and the mammal using other keywords or other entities that are identified along with a particular entity in question.

For example, if a query included the terms “Jaguar” and “dealer,” a confidence score might be greater as it relates to the car manufacturer than for either of the beetle or the mammal. As another example, if a query included the terms “Jaguar” and “zoo” a confidence score might be greatest for the mammal, then the beetle, and then the car manufacturer. In some implementations, only entity identifiers that satisfy a threshold confidence score are designated.

Those elements in the queries 116 that are determined to be associated with entities are added to a collection of annotation results 206. For example, each query 116 having multiple terms can be evaluated and entities associated with the terms can be identified. This process can be repeated for any or all queries 116 that are received by the content management system 110.

In some implementations, the annotation results 206 can be stored. For example, the annotation results can be stored in the content item repository 128 (FIG. 1) or other types of data stores. In some implementations, the stored annotations can be used in subsequent attempts to determine commercial intent, e.g., by way of an iterative process of receiving addition queries and determining whether the queries 116 include terms that indicate a commercial intent.

The commercial intent identifier 208 can receive the annotation results 206, and in some implementations the stored annotations, and generate one or more scores for each entity that reflects a likelihood that a particular entity indicates a commercial intent for a user that submits the request. In other words, the commercial intent identifier 208 can identify one or more entities to select based on the determined commercial intent. For example, the commercial intent identifier 208 can determine that the “Jaguar” entity corresponding to the car manufacturer should be selected instead of the “Jaguar” entity corresponding to beetle when a search query for “jaguar beetle dealership” is received. The commercial intent identifier 208 is described in more detail below.

Depending on whether the content management system 110 is operating in an off-line process 202a or a real-time process 202b, the results of the commercial intent identifier 208 can be provided to the query to entity targeting data mappings repository 210, and a content item matcher 212, respectively.

In general, the query to entity targeting data mappings repository 210 provides storage so that determinations made by the commercial intent identifier 208 can be stored for future use. For example, if a query “jaguar beetle dealership” is received and the keyword “jaguar” is determined to be for the entity that corresponds to the car dealership, information describing this determination can be stored in the query to entity targeting data mappings repository 210. Then, at some future time, if another query similar to “jaguar beetle dealership” is received, the information stored in the query to entity targeting data mappings repository 210 can be used to identify that the keyword “jaguar” corresponds to the car dealership entity. Such an identification may be made instead of or in addition to determinations performed by the commercial intent identifier 208. As a result of storing associations in the query to entity targeting data mappings repository 210, the performance of subsequent entity determinations can be improved.

In general, the content item matcher 212 can use the identified entity to serve content that is responsive to the received query. For example, if the commercial intent identifier 208 identifies the car dealership entity “Jaguar” as being a likely entity for a received search query, the content item matcher 212 can use that identification to provide content items, such as advertisements, for one or more Jaguar cars that are responsive to the search query. In general the associations between entities and potential content items can be specified using various techniques. For example, a particular advertiser, such as the Jaguar car manufacturer can provide a number of content items to a content item server. In response to receiving the content items, the content item server can associate the content items with the entity that corresponds to the Jaguar car manufacturer.

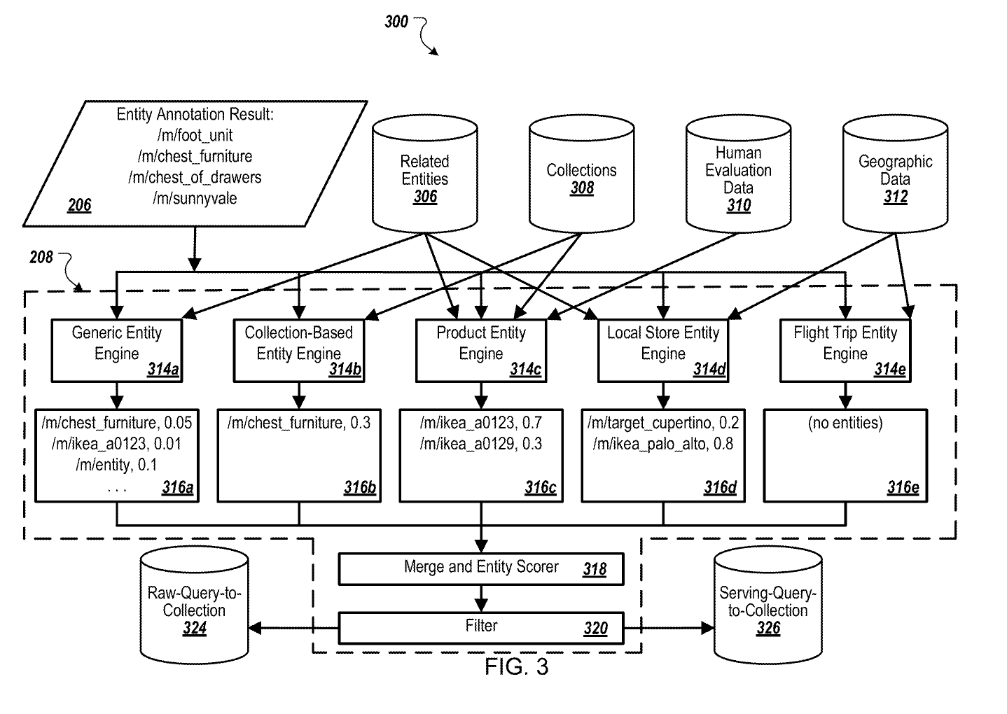

FIG. 3 is a block diagram 300 of an example commercial intent identifier 208. In general, the commercial intent identifier 208 can receive one or more annotation results 206. Using the received annotation results 206, the commercial intent identifier 208 can determine a commercial intent based on one or more collections in which a particular entity or multiple entities appear. Using the commercial intent, the commercial intent identifier can select one or more likely commercial entities that can be used as selection criteria for one or more content items. As is shown in the depicted example, and described above in reference to FIG. 2, the commercial intent identifier 208 can receive one or more annotation results 206. For example, consider a search request for a “4 foot chest of drawers in Sunnyvale.” The search request can be annotated to identify the “4 foot” keywords as being associated with the “/m/foot_unit” entity, the “chest” keyword as being associated with the “/m/chest_furniture” entity, the “chest of drawers” keywords as being associated with the “/m/chest_of_drawers” entity, and the “Sunnyvale” keyword as being associated with the “/m/sunnyvale” entity.

In some implementations, the commercial intent identifier 208 can use one or more entity engines to determine a commercial intent for the Entity Annotation Result 206. In the depicted example, the commercial intent identifier can access a related entities data store 306, a collections data store 308, a human evaluation data store 310, and a geographic data store 312, although other data stores may also be available.

In general, each data store includes information that allows particular entity engines 314a-314e to generate a score that indicates a likelihood that an entity is indicative of commercial intent. For example, the related entities data store 306 can store associations of related entities. In a particular example, the entity “Jaguar” that is associated with the car manufacture may be associated with the entity for the car manufacturer “Acura.” This association can be stored in the related entities data store 306 and used to determine a commercial intent based on one entity being associated with another entity that indicates commercial intent.

The collections data store 308 can store one or more collections and associations as to whether particular collections are indicative of commercial intent. For example, a car manufacturer collection may be highly indicative of commercial intent when an entity is found within that collection. As another example, a collection for mammals may be less indicative of commercial intent.

The human evaluation data store 310 can store information about the behavioral patterns of users that can be used to determine commercial intent. For example, when a user selects an advertisement that is associated with an entity, that selected can be stored. In the future, if a commercial intent for that particular entity is being ascertained, the selection of the advertisement that is associated with the entity may be highly indicative of a commercial intent.

The geographic data store 312 can be used to store information about locations of various entities. For example, certain types of geographic locations, such as malls, restaurants, and other locations, may be highly indicative of commercial intent. Other locations, however, such as a person's home address or a public park, may be less indicative of commercial intent.

In the depicted example, each of the entity engines 314a-314e can receive information from one or more of the data stores 306-312 to determine a commercial intent for that particular entity engine. For example, the generic entity engine 314a can receive information from the related entities data store 306 to determine whether an entity, in general, indicates a commercial intent. As another example, the collection-based entity engine 314b can receive information from the collections data store 308 to determine whether a collection in which a particular entity is included indicates a commercial intent. As another example, the product entity engine 314c can receive information from the related entities data store 306, the collections data store 308, and the human evaluation data store 310 to determine a likelihood that the entity is a product and/or associated with a product, which indicates a commercial intent. As another example, the local store entity engine 314d can receive information for the related entities data store 306 and the geographic data store 312 to determine whether an entity is associated with a store or other location that indicates a commercial intent. The flight trip entity engine 314e can receive information from the geographic data store 312 to determine whether the entity is associated with an intent to travel, which may be indicative of a commercial intent.

Each entity engine 314a-314e can utilize information stored in various data repositories when determining one or more entity-score pairs 316a-316e. Each of the entity-score pairs 316a-316e can be provided to a merge and entity scorer module 318. For example, the generic entity engine 314 can determine that the “/m/chest_furniture” entity in the Entity Annotation Result 206 has a commercial intent score of 0.05. Also, the generic entity engine 314a may determine that a related entity “/m/ikea_a0123,” e.g., based on associations in the related entities data store 306, has a commercial intent score of 0.01.

Similar determinations can be made using the other entity engines 314b-314e. Each of the engines may generate different scores based on the evaluation being performed. For example, the collection-based entity engine 314b can determine that the entity “/m/chest_furniture” has a commercial intent score of 0.3, which is higher than the score for the same entity determined by the generic entity engine 314a. The score may be higher in this instance because, e.g., the entity “/m/chest_furniture” is included in a number of collections that have been associated with a commercial intent and the collection-based entity engine 314b uses those associations to determine a commercial intent score. Whereas the generic entity engine 314a may look at other information, such as entity relationships, to determine a commercial intent score.

Similarly, the product entity engine 314c has determined that the entity “/m/ikea_a0123” has a score of 0.7, which is also higher than the score of 0.01 determined by the generic entity engine 314a. Again, the score may be higher in this instance because, e.g., the entity “/m/ikea_a0123” is associated with one or more products that are highly indicative a commercial intent.

As is shown in the depicted example, not all entity engines will produce an entity-score pair. For example, the flight trip entity engine 314e has not scored any entities because, in this particular example, none of the entities in the Entity Annotation Result 206 or entities that can are determined to be related to the entities in the Entity Annotation Result 206 are indicative of a flight, trip, or other travel.

In some implementations, the entity engines 314a-314e can run independently of each other. For example, the entity engines 314a-314e can run in parallel to process one or more entities in the Entity Annotation Result 206. In such embodiments, the engines may determine their respect entity-score pairs at different rates, e.g., based on the amount of information received from the various data stores 306-312 and other constraints, such as whether a particular entity engine 314a-314e is operating in an offline process 202a or a real-time process 202b. As a result, each of the entity engines 314a-314e may determine entity-score pairs at different times even when the engines 314a-314e received a particular entity for consideration at substantially the same time.

Because the entity-score pairs may be determined at different rates, it may be helpful to defer a final determination of commercial intent until some amount of time has elapsed. For example, the merge and entity scorer module 318 can collect entity-score pairs determined by the different entity engines 314a-314e over time and then determine an engine independent score for the results from the entity engines 314a-314e. For example, the merge and entity scorer module 318 can weigh certain scores based on the engine from which those scores were received. For example, the scores received from the generic entity engine 314a may be lower than scores received from the product entity engine 314c. As a result, the merge and entity scorer module 318 may determine a higher score or a lower score for an entity in a particular entity-score pair compared to the score that was determined by a corresponding entity engine 314a-314e.

The one or more values determined by the merge and entity scorer module 318 can be provided to a filter 320. In general, the filter can consolidate the various entity-score pairs and provide the entity-score pairs to a raw serving query to collection data store 324 and a serving query to collection data store 326. Depending on the data store 324 or 326 that is receiving the consolidated information, the filter 320 may remove particular entities from consideration if the score is not sufficient high or if the entity does not belong to a particular predetermined collection. For example, the filter 320 may filter the entity-score pairs so that only a highest or a few of the highest entity-score pairs are provided to the serving query to collection data store 326. Alternatively, the filter may not filter the entity-score pairs when those entity-score pairs are being provided to the raw query to collection data store 324.

In general, the raw query to collection data store 324 does not have a size restriction. This enables all data to be stored in the raw query to collection data store 324. As a result, different entity-score pairs can be inspected to determine whether techniques described above are providing suitable selection criteria results. The serving query to collection data store 326, however, has limited space because it is used in serving one or more content items, and an overly large data store may slow down the serving of the content items. As a result, the serving query to collection data store 326 may include fewer entity-score pairs than the raw query to collection data store 324 for a particular query. In some implementations, only a top 10 highest entity-score pairs are stored for a particular query, although other numbers of top queries can also be stored.

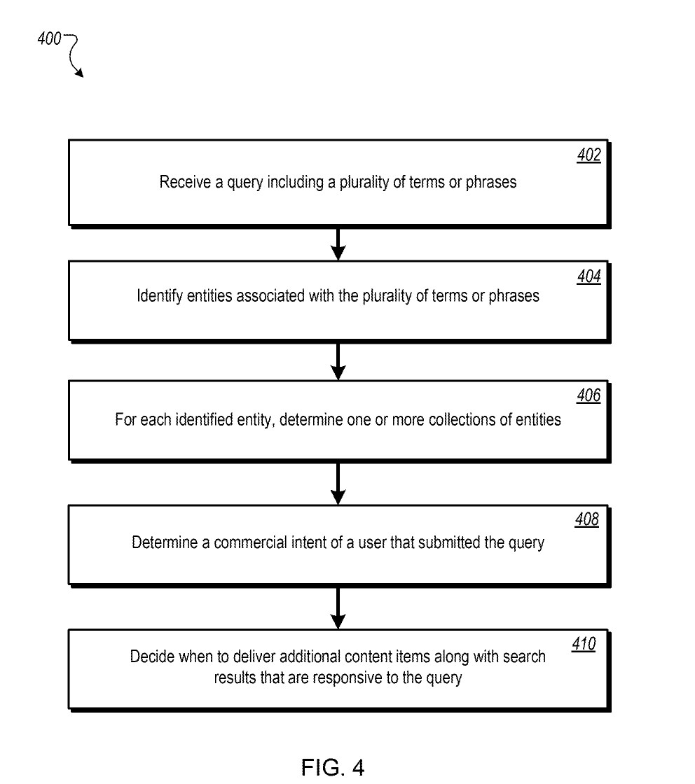

FIG. 4 is a flowchart of an example process 400 for determining commercial intent. The process 400 can be performed, for example, by the content management system 110 and associated components described above with respect to FIGS. 1 and 2. But other systems and components may be configured to perform the process 400. In general, the process 400 determines commercial intent of a received search query and generates selection criteria for one or more content items based on the determined commercial intent.

A query that includes a plurality of terms or phrases is received (402). For example, content management system 110 (FIG. 1) can receive a search query 116, such as search query “4 foot steel dining table in Sunnyvale” from a user or other provider of the search query 116.

Entities associated with the plurality of terms or phrases are identified (404). For example, the search query can be provided to the annotator 204 (FIG. 2). The annotator can identify the entities using various parsing and comparison techniques. For example, the annotator may identify entities that correspond to keywords or phrases “4 foot,” “steel,” “table,” “dining table,” and “Sunnyvale” in the query “4 foot steel dining table in Sunnyvale.” In some implementations, different keywords may lend themselves to being identified as one or more entities. For example, the keyword “steel” may also map to an entity for the comic book character “Steel,” or the movie “Steel,” each of which would be a distinct entity. Similarly, the term “table” may have any number of possible entities including a Hypertext Markup Language (HTML) element, a furniture table, a database table, a way of aggregating information, and furniture. The subsequent steps can be performed on all of the identified entities to determine a commercial intent.

For each of the identified entities, one or more collections of entities is determined (406). For example, the content management system 110 can access one or more collections and identify the collections in which the entities are includes. For example, the entity “4 foot” may be included in a units-of-length collection. As another example, the entity “steel” may be included in a materials collection. Also, as yet another example, the entity associated with the comic book character “steel” may be included in a comic book collect, a movie collection, or other similar collection.

In some implementations, determining one or more collections includes determining a collection that includes all of the identified entities. For example, a furniture collection may include entities for “4 foot,” “steel,” “dining table,” and “Sunnyvale.” Although in some implementations, a location entity may be omitted from determining when a collection includes all of the identified entities. In some implementations, determining one or more collections includes determining whether the one or more entities belong to white list collections only. For example, certain collections are highly indicative of commercial intent, while other collections may not be indicate of any commercial intent. As a result, in some implementations, only the whitelist collections are used to determine whether a particular entity belongs to a particular collection.

A commercial intent for a user that submitted the query is determined (408). For example, the commercial intent identifier 208 (FIG. 3) can determine commercial intent by determining entity-score pairs for the various entities and the collections in which those entities appear. For example, the entity “table” may have a higher commercial intent score for the furniture table entity than the entity associated with a way of aggregating information. This may be, e.g., because the furniture table entity is included in a furniture collection that has been associated with a commercial intent that is higher than the commercial intent of a collection that includes the entity for a way of aggregating information. In other words, in some implementations, determining a commercial intent includes evaluating the criteria for inclusion in a collection and using the criteria to infer commercial intent.

When to deliver additional content items along with search results that are responsive to the query is decided (410). For example, the determination of whether a search query is indicative of commercial intent can be used to determine whether to provide, or not to provide additional content items. For example, in some implementations, deciding includes deciding to deliver additional content items when the commercial intent is determined to be an intent to purchase a good or service. As another example, in some implementations, deciding includes deciding to not deliver additional content items when the commercial intent is determined to not be an intent to purchase a good or service.

In a particular example, techniques described herein can be used to determine a commercial intent for a search query of “4 foot steel dining table in Sunnyvale” while for a search query of “video cat running on bookshelf,” commercial intent would not be indicated by the determination. As a result, content items related to that commercial intent, e.g., a table that matches the query, other materials of table, and so forth may be provided for the search query “4 foot steel dining table in Sunnyvale” along with the search results that are responsive to the request. Conversely, because no commercial intent was determined for the search query “video cat running on bookshelf,” only search results responsive to the request are provided.

In some implementations the determined one or more collections can be used to select the additional content items to be delivered along with the search results. For example, additional content items associated with other entities in the collection may be selected for delivery along with the original content items and/or the search results. This may be, e.g., because the particular user has indicated a preference for particular ones of the other entities, or for other reasons.

In some implementations, determining one or more collections includes determining that one of the one or more collections is a blacklist collection and wherein determining the commercial intent of the user includes inferring that the commercial intent of the user that submitted the query is not to purchase a good or service based on the identification of the blacklist collection. The blacklist may be a single collection or a combination of collections. For example, a techniques described herein can be used to map a query “video cat running on bookshelf” to a hobbies collection, an animal collection, a sports collection, and a furniture collection. A combination of the hobbies collection, an animal collection, and a sports collection may compared to a blacklist of collections or combinations of collections to determine that the query is not indicative of commercial intent, even though the query included a term “bookshelf” which may, under other circumstances, be indicative of commercial intent.

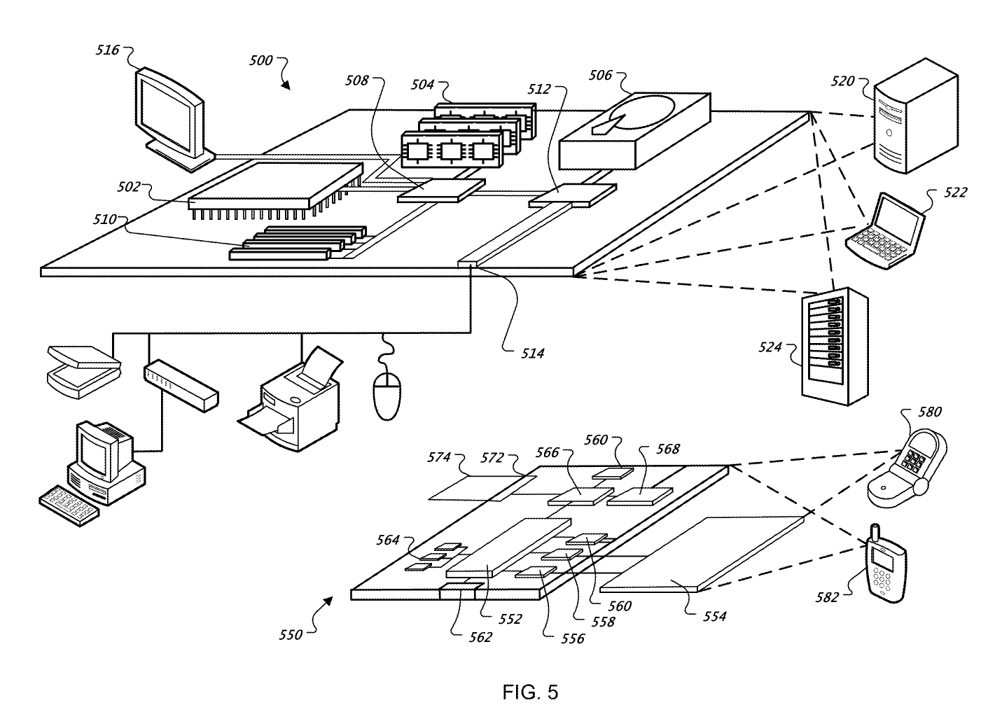

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. The computer-readable medium is not a propagating signal. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of duties is illustrative only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communication audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A computer-implemented method comprising:
receiving a query including a plurality of terms or phrases;
identifying entities associated with the plurality of terms or phrases;
for each identified entity, determining one or more collections of entities wherein a determined collection of entities includes a respective identified entity as a member;
determining a commercial intent of a user that submitted the query including evaluating the determined one or more collections of entities; and
based on the determined commercial intent, deciding when to deliver additional content items along with search results that are responsive to the query.

2. The method of claim 1 wherein determining one or more collections includes determining a collection that includes all of the identified entities.

3. The method of claim 1 wherein determining a commercial intent includes evaluating the criteria for inclusion in a collection and using the criteria to infer commercial intent.

4. The method of claim 1 wherein deciding includes deciding to deliver additional content items when the commercial intent is determined to be an intent to purchase a good or service.

5. The method of claim 1 wherein deciding includes deciding to not deliver additional content items when the commercial intent is determined to not be an intent to purchase a good or service.

6. The method of claim 1 wherein the additional content items are advertisements.

7. The method of claim 1 further comprising using the determined one or more collections to select the additional content items to be delivered along with the search results.

8. The method of claim 1 wherein determining one or more collections includes determining that one of the one or more collections is a blacklist collection and wherein determining the commercial intent of the user includes inferring that the commercial intent of the user that submitted the query is not to purchase a good or service based on the identification of the blacklist collection.

9. The method of claim 1 wherein a collection is a group of entities that share a common characteristic.

10. A computer program product embodied in a non-transitive computer-readable medium including instructions, that when executed, cause one or more processors to:
receive a query including a plurality of terms or phrases;
identify entities associated with the plurality of terms or phrases;
for each identified entity, determine one or more collections of entities wherein a determined collection of entities includes a respective identified entity as a member;
determine a commercial intent of a user that submitted the query including evaluating the determined one or more collections of entities; and
based on the determined commercial intent, decide when to deliver additional content items along with search results that are responsive to the query.

11. The computer program product of claim 10 wherein determining one or more collections includes determining a collection that includes all of the identified entities.

12. The computer program product of claim 10 wherein determining a commercial intent includes evaluating the criteria for inclusion in a collection and using the criteria to infer commercial intent.

13. The computer program product of claim 10 wherein deciding includes deciding to deliver additional content items when the commercial intent is determined to be an intent to purchase a good or service.

14. The computer program product of claim 10 wherein deciding includes deciding to not deliver additional content items when the commercial intent is determined to not be an intent to purchase a good or service.

15. The computer program product of claim 10 wherein the additional content items are advertisements.

16. The computer program product of claim 10 further including instruction to use the determined one or more collections to select the additional content items to be delivered along with the search results.

17. The computer program product of claim 10 wherein determining one or more collections includes determining that one of the one or more collections is a blacklist collection and wherein determining the commercial intent of the user includes inferring that the commercial intent of the user that submitted the query is not to purchase a good or service based on the identification of the blacklist collection.

18. The computer program product of claim 10 wherein a collection is a group of entities that share a common characteristic.

19. A system comprising:
an annotator for annotating each of one or more received search queries with one or more entities;
a commercial intent identifier for receiving annotation results and generating one or more scores for each entity that reflects a likelihood that a particular entity indicates a commercial intent for a user that submits the request; and
a content item matcher for using the identified entity to serve content that is responsive to the received query.

20. The system of claim 19 wherein determining a commercial intent includes evaluating criteria for inclusion in a collection and using the criteria to infer commercial intent.
